(19) United States
(12) Patent Application Publication
(10) Pub. No.: US 2002/0095935 A1
(43) Pub. Date: Jul. 25, 2002

(54) Single shaft hybrid supercharger system

(76) Inventor: Davorin D. Kapich, Carlsbad, CA (US)

Correspondence Address: John R. Ross, lll, Ross Patent Law Office, P.O. Box 2138, Del Mar, CA, 92014, US

(21) Appl. No.: 09/767,428

(22) Filed: Jan. 22, 2001

(51) Int. Cl. F02B 33/00

(52) U.S. Cl. 60/599; 123/561

(57) ABSTRACT

A hybrid supercharger system for internal combustion engines. A hydraulic turbine drive driven by hydraulic fluid is mounted on the same shaft with an exhaust driven turbine, with both turbines driving a compressor providing compressed air to the engine. Engine oil is utilized to lubricate at least one bearing located on the exhaust portion of the shaft and the hydraulic drive fluid is used to lubricate at least one bearing on the hydraulic turbine portion of the shaft. In a preferred embodiment four bearings are provided, two of which are lubricated by engine oil and two of which are lubricated with hydraulic turbine drive fluid.

This invention relates to supercharger systems for internal combustion engines.

### BACKGROUND OF THE INVENTION

Superchargers are air pumps or blowers in the intake system of internal combustion engine for increasing the mass flow rate of air charge and consequent power output from a given engine size. Turbosuperchargers (normally called turbochargers) are engine exhaust gas turbine driven superchargers. When superchargers are driven mechanically from the shaft of the internal combustion engine, a speed increasing gear box or belt drive is needed. Such superchargers are limited to a relatively low rotating speed and are large in size. Paxon Blowers and Vortech Engineering Co. are marketing such superchargers. Fixed gear ratio superchargers suffer from two very undesirable features: 1) there is a sharp decrease in boost pressure at low engine RPM because boost pressure goes generally to the square of the speed of rotation, and 2) it is generally difficult to disconnect the supercharger from the engine when the supercharger is not needed.

Applicant was granted on Dec. 5, 1995 a patent (U.S. Pat. No. 5,471,965, incorporated by reference herein) on a very high-speed radial inflow hydraulic turbine. FIG. 12 of that patent discloses the hydraulic turbine driven blower used in combination with a conventional turbocharger to supercharge an internal combustion engine. In that embodiment the output of the hydraulic driven compressor was input to the compressor of the conventional turbocharger so that the system was in a sense a hybrid supercharger system. At high speeds when the exhaust driven turbosupercharger is fully capable of supplying sufficient compressed air to the engine, a bypass valve unloaded the hydraulic fluid.

Another hybrid supercharger is disclosed in U.S. Pat. No. 4,285,200 (incorporated by reference herein) issued to Byrne on Aug. 25, 1981. That patent disclosed a compressor driven by an exhaust driven turbine and a hydraulic driven turbine, the compressor and both turbines being on the same shaft. That turbine was an axial flow turbine that was driven with engine oil. With this design oil foaming can be a problem. In U.S. Pat. No. 5,924,286 (incorporated by reference herein) Applicant described a better hybrid supercharger driven by both exhaust gas and hydraulic fluid. In that described unit the bearings of the hybrid unit were lubricated with the same hydraulic fluid that drove the hydraulic turbine. This arrangement created certain problems.

What is needed, is a supercharger system that overcomes these problems.

### SUMMARY OF THE INVENTION

The present invention provides a hybrid supercharger system for internal combustion engines. A hydraulic turbine drive driven by hydraulic fluid is mounted on the same shaft with an exhaust driven turbine, with both turbines driving a compressor providing compressed air to the engine. Engine oil is utilized to lubricate at least one bearing located on the exhaust portion of the shaft and the hydraulic drive fluid is used to lubricate at least one bearing on the hydraulic turbine portion of the shaft. In a preferred embodiment four bearings are provided, two of which are lubricated by engine oil and two of which are lubricated with hydraulic turbine drive fluid.

### BRIEF DESCRIPTION OF THE DRAWINGS

FIG. 1 is a cross sectional drawing showing a preferred embodiment of a very high-speed turbine drive.

FIG. 2 is a drawing showing an exploded view of a prior art turbocharger.

FIGS. 3 and 4 are drawings showing views of the nozzle arrangement of the turbine drive shown in FIG. 1.

FIG. 5 shows a nozzle body design.

FIG. 6 is a prospective view of the FIG. 5 nozzle body.

FIG. 7 is a drawing showing the detail dimensions of turbine blades used with the nozzle body shown in FIGS. 5 and 6.

FIG. 8 is a drawing showing the positions of the turbine blades on the turbine wheel.

FIG. 9 shows a preferred embodiment of the present invention.

### DETAILED DESCRIPTION OF PREFERRED EMBODIMENTS

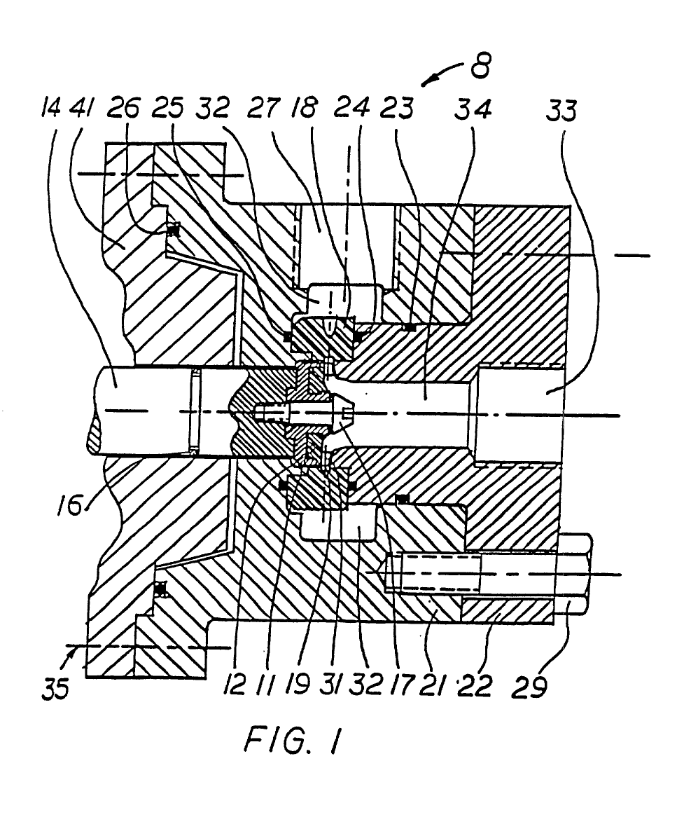

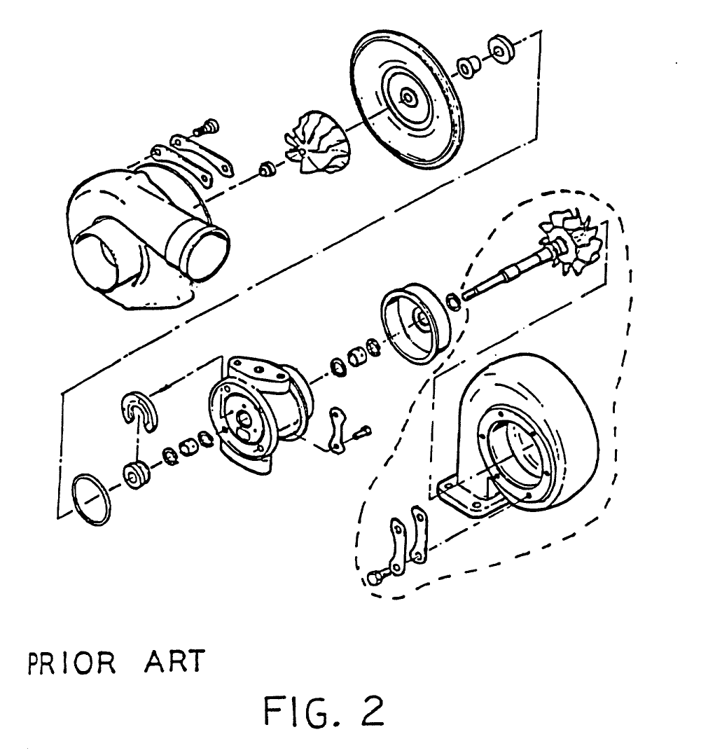

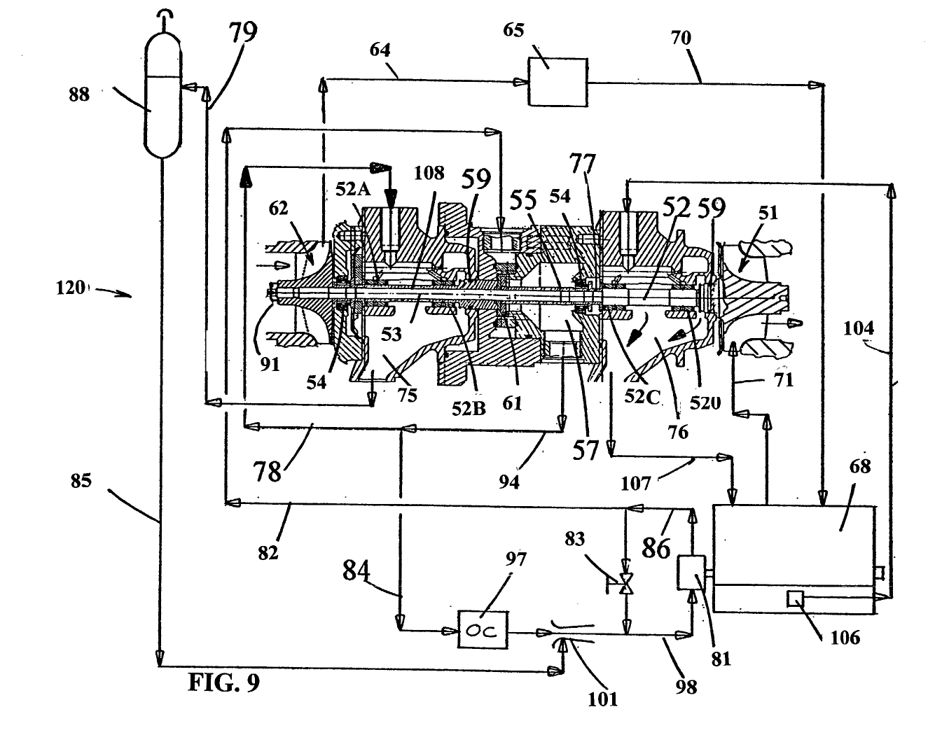

Preferred embodiments of the present invention are described by reference to the drawings. FIGS. 1 through 8 describes the fabrication and operation of a hydraulic driven supercharger. FIG. 9 shows a preferred embodiment of the present invention that is a single-shaft hybrid supercharger system. A single shaft powered by a hydraulic turbine and an engine exhaust driven turbine drives a compressor. The hydraulic fluid lubricates one set of shaft support bearings and another set of shaft support bearings is lubricated with engine oil.

### Turbine Drive

A prior art turbine drive is shown in FIGS. 1, 2, 3 and 4, which are extracted from U.S. Pat. No. '965. The features of this drive ate described below.

Turbine Wheel

The turbine drive, with a wheel of only 0.800-inch diameter, is capable of generating 20 HP at 70,000 RPM, with pressure differentials of 1450 psi and having the capability of operating at the fluid temperatures of 150 to 250 degrees Fahrenheit.

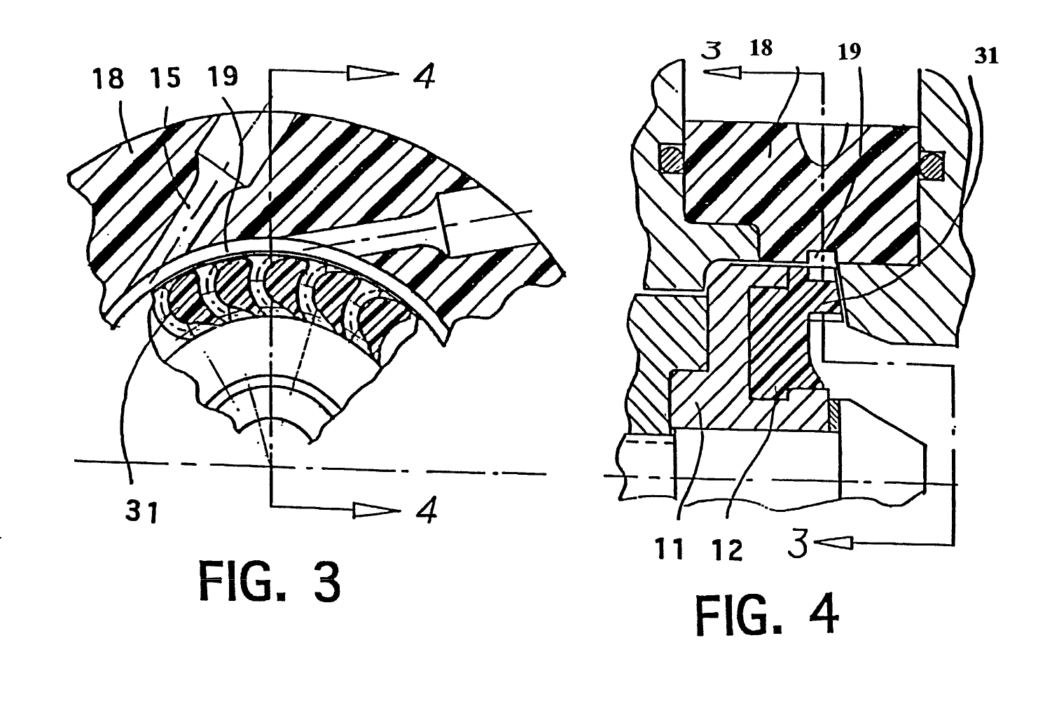

Turbine drive 8 shown in FIG. 1 includes turbine wheel 11 with 27 turbine blades 31. To make turbine wheel 11 the plastic is pressure injected into a mold containing a containing wheel 12 (which is a metal such as steel) forming an integral assembly of plastic turbine wheel 11, metal wheel 12 and plastic turbine blades 31. The metal containing wheel 12 is precisely centered into the turbocharger shaft 14 and held axially by self-locking steel fastener 17 as shown in FIG. 1. Compressive load generated by the self locking steel fastener 17 is sufficient to facilitate the torque transfer from the metal containing wheel 12 into the turbocharger shaft 14 under all anticipated torque loads, fluid temperatures and rotating speeds. During the normal operation the temperature of hydraulic oil is usually in the range of 150 to 250 degrees Fahrenheit which expands the metal containing wheel 12 axially slightly more than the self locking steel fastener 17 and the turbocharger shaft 14, thus increasing the compressive load in the metal containing wheel 12 and the torque transfer capability slightly above the cold assembly condition. The centrifugally and thermally induced stresses in the plastic turbine wheel 11 which is solidly anchored inside the metal containing wheel 12 are to a great extent being absorbed by the metal containing wheel 12. As indicated on FIG. 3 and FIG. 1, the plastic turbine blades 31 are of the radial inflow type with rounded leading edges to minimize the erosion tendency sometime caused by very high hydraulic oil velocity as combined with sharp, thin leading edges. The radial inflow type blading geometry allows, after the blades are cast, the plastic mold to be withdrawn axially out from the blades. The blades of the turbine wheel are preferably made of high strength thermoplastic material, Polysulfone which is pressure injected into a mold holding the steel portion of the wheel which together form an integral metal/plastic turbine wheel and blade. Vespell, a high temperature plastic made by DuPont, has also been successfully tested for this application.

Turbine Parts and its Operation

Turbine discharge housing 22 is solidly bolted by six bolts 29 to the turbine inlet housing 21 which is solidly bolted by a series of bolts at 35 to the commercially supplied (T04 form Turbonetics) turbocharger housing 41 as shown in FIG. 1. Turbine nozzle ring 18 preferably made from Vespel is held in a precise axial and radial position by the turbine inlet housing 21 and the turbine discharge housing 22. (Nozzle ring 18 could also be made from brass or any of several other similar metals.) Nozzle ring 18, inlet housing 21 and discharge housing 22 together define toroidal inlet cavity 32 as shown in FIG. 1. The high oil pressure contained inside inlet cavity 32 is sealed by O-Ring 24 and O-Ring 25 which prevent any leakage from inlet cavity 32 to the discharge cavity 34 along the contact surfaces between turbine nozzle ring 18, turbine inlet housing 21 and turbine discharge housing 22. A substantial portion of the inside diameter of the turbine nozzle ring 18 is supported radially by matching diameters of turbine inlet housing 21 and turbine discharge housing 22 which restrain radial deformation of the turbine nozzle body 18 and to a great degree absorb inwardly compressive pressure generated by the high pressure hydraulic fluid contained inside inlet cavity 32. The axial dimension of the turbine nozzle ring 18 is precisely matched with the axially allowable space between turbine discharge housing 22 and turbine inlet housing 21. At normal operating temperatures the turbine nozzle ring 18 expands slightly more than the matching surfaces of turbine inlet housing 21 and turbine inlet housing 22 which essentially restrain the axial expansion of the turbine nozzle ring 18 and produces a moderate axial compressive stress in the turbine nozzle ring 18. Commercially supplied sliding seal ring 16 provides the oil seal between the commercially supplied turbocharger housing 41 and the turbocharger shaft 14. O-Ring 26 seals the relatively low oil pressure around the turbocharger shaft 14 from leaking to ambient. O-Ring 23 seals the high oil pressure contained in inlet cavity 32 from leaking to ambient.

As indicated in FIGS. 3 and 4, in this embodiment sixteen turbine nozzles 15 are drilled in a radial plane, through the turbine nozzle ring 18 at an angle of 11 degrees with the tangent to a circle of the plastic turbine blades 31 outer diameter. The center lines of the turbine nozzles 15 positioned in a radial plane cause high pressure hydraulic fluid to expand radially inward from the inlet cavity 32 through turbine nozzles 15 into the vaneless passage 19 and into the inlet of the plastic turbine blades 31 where the hydraulic fluid momentum is converted into shaft power by well known principles. FIG. 3 shows the plan view of the exit portion of the turbine nozzles 15 as viewed in the planes 3-3 in FIG. 4. FIG. 4 shows a section through the nozzle ring 18 along the plane 4-4 in FIG. 3. High hydrodynamics efficiency of nozzles 15 is attributed to the particular combination of rounded cross-sectioned turbine nozzles 15 and the gradual change in the cross section of the flow area along the centerline axis of the individual turbine nozzles 15 as shown in FIG. 3. The sixteen turbine nozzles 15 are positioned close to each other within the turbine nozzle ring 18 so as to produce minimum wakes of low velocity fluid in the vaneless passage 19 and turbine blades 31. Such wakes are considered to be generally harmful to the turbine hydraulic efficiency. Such nozzle positioning as shown in FIG. 3 and 4 maximizes the percentage of the turbine blades radial flow area occupied by the high velocity fluid relatively to the radial flow area occupied by the wakes. Also, providing vaneless passage 19 permits each of nozzles 15 to be drilled without drilling into other nozzles.

During operation high pressure hydraulic fluid (preferably at about 1500 psi) enters the turbine via inlet channel 27. It flows into inlet cavity 32 that supplies the fluid flow to the 16 nozzle passages 15 that are contained within turbine nozzle ring 18. The fluid flow accelerates through nozzle passages 15 converting pressure energy into kinetic energy which is then utilized to provide a driving force to the plastic turbine blades 31. Fluid exits from the plastic turbine blades 31 into exit cavity 34 and is discharged at low pressure through exit channel 33.

### Improved Turbine Design

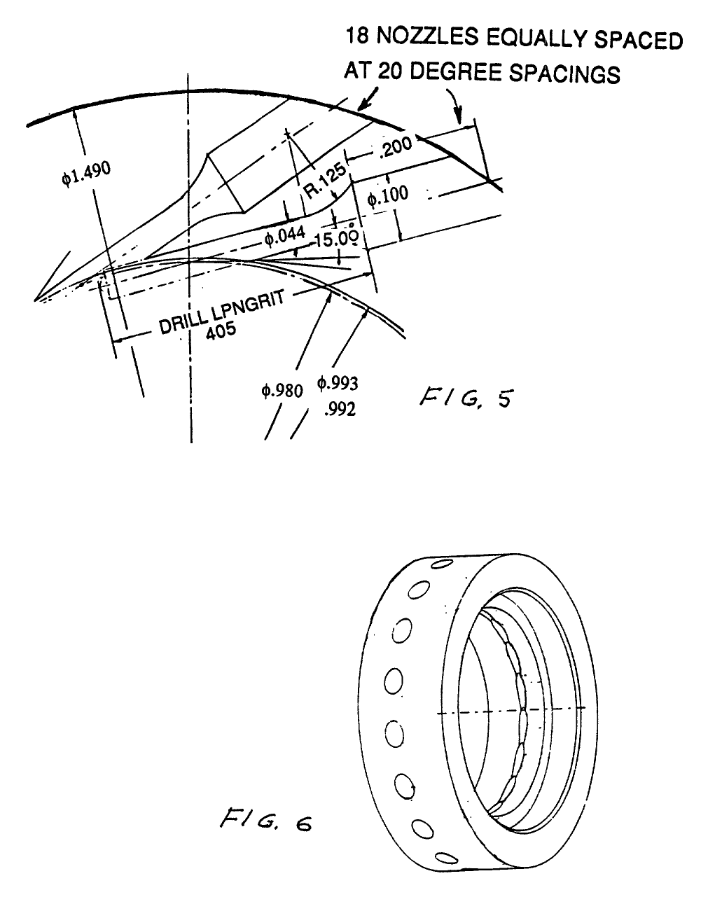

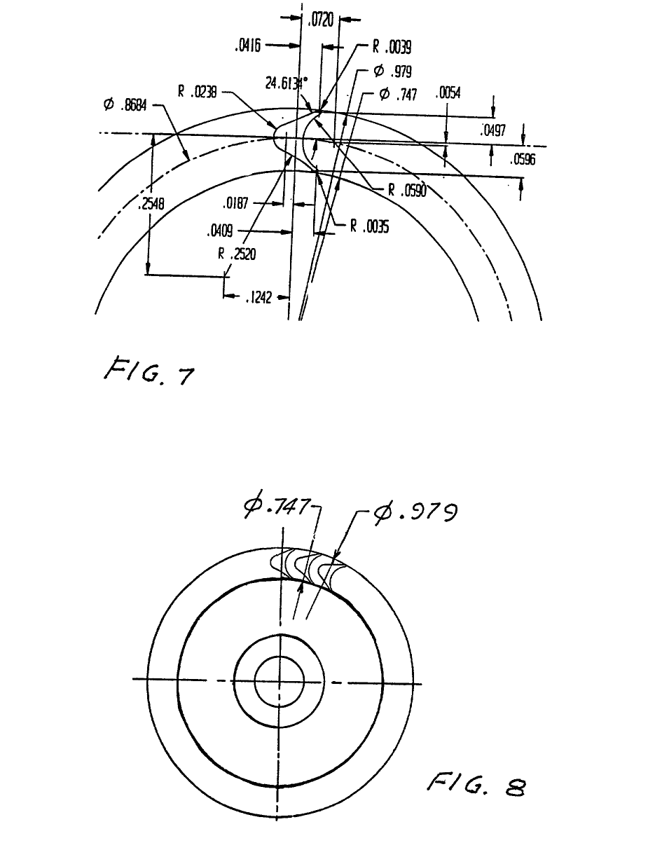

FIGS. 3 and 4 show a preferred nozzle body configuration, which is described above. An alternate design is shown in FIGS. 5 through 8. In this alternate design the angle of the nozzle is changed slightly and the total nozzle flow area has remained approximately the same while the individual nozzle throat diameters have been decreased and the number of nozzle holes has been increased to the point where the nozzle exit holes are overlapping each other by about 22 percent of the peripheral length of each nozzle exit. By peripheral length of each nozzle exit, I mean the long dimension of the oval made by the intersection of the exit hole with the inside surface of the nozzle body. FIG. 5 shows the 18-nozzle configuration in the preferred embodiment with nozzle angles of 13 degrees to the tangent on a diameter of 0.993 inch with a 0.044-inch individual nozzle throat diameter. FIG. 6 shows a perspective view of the nozzle body with individual nozzles overlapping each other by about 20 percent. FIGS. 7 and 8 show new improved turbine wheel blades configured for higher efficiency. More uniform distribution of nozzles flow and nozzles flow angle around the turbine wheel periphery provides for a more uniform inlet flow angle into the rotating turbine blades which allows for a sharper turbine blades leading edges and lower blade losses without potential flow separation at the blade inlets. Combination of overlapping nozzles and the FIGS. 7 and 8 wheel blades as compared to nozzles and blades shown in FIG. 3 and turbine blades shown in FIG. 9 has produced an approximately 7 percent increase in the overall efficiency of the supercharger. Applicant has determined that exits holes overlaps of between about 20 to 25 percent provides best results. Applicant has built and tested units having turbine wheels with 26, 28 and 32 blades.

### Single Shaft Hybrid Supercharger System

FIG. 9 shows a hybrid supercharger system 120 supercharging internal combustion engine 68. In this embodiment compressor wheel 62 is driven on a single shaft by engine exhaust turbine 51 and by hydraulic turbine 61. Engine exhaust is provided to turbine 51 by exhaust line 71 and hydraulic fluid is provided to hydraulic turbine 61through line 82 by hydraulic pump 81 driven by the engine shaft. The hydraulic turbine design is substantially the same as described above with respect to FIGS. 1 through 8 with minor changes to fit it on the single shaft with the engine exhaust driven turbine.

Engine Exhaust Turbine

Engine exhaust turbine 51 is a standard turbocharger turbine such as the turbine portion of the TO4B-V turbocharger. It is driven as stated above by engine exhaust from engine 68 through exhaust pipe 71 and the exhaust from the turbine is to the ambient.

Supercharger Compressor

Compressor 62 is a standard turbocharger compressor also such as the compressor portion of the TO4B-V turbocharger. The exhaust from compressor 62 is directed through line 64, air to air aftercooler 65, and line 70 into the intake manifold of engine 68.

Hydraulic Inflow Radial Turbine

Hydraulic turbine 61 in this embodiment shown in FIG. 9 is similar to the hydraulic inflow radial turbine described in FIG. 1 and FIGS. 5 through 8. The FIG. 9 turbine having a wheel diameter of only 0.800 inch is capable of generating 20 HP at 70,000 RPM, with pressure differentials of 1450 psi. The unit is capable of operating at the fluid temperatures of 150 to 250 degrees Fahrenheit. As shown in FIG. 9 hydraulic turbine 61 is solidly coupled to shaft 53 and supported rotatably by bearings 52 A, B, C and D. During engine operation engine exhaust drives turbine 51 which is transferring power to compressor wheel 62 through shaft 53. When additional engine power is required high-pressure hydraulic fluid is supplied via line 82 to turbine 61 which augments the power produced by turbine 51. This additional power increases the rotational speed of shaft 53 and compressor wheel 62 producing increased air flow which is supplied to engine 68 via line 64 aftercooler 65 and line 70. Pump 81 driven by engine 68 supplies high-pressure fluid to hydraulic turbine 61 via line 82 when added charging is needed. Bypass valve 83 allows hydraulic fluid to bypass hydraulic turbine 61 thus unloading pump 81. Hydraulic fluid is discharged from turbine 61 via line 94 returning the fluid to pump 81 via line 84, oil cooler 97, venturi 101 and line 98.

Bearings

Two sets of bearings 52A and 52B and 52C and 52D are provided. One set of bearings 52 A and B is located in the compressor bearing cavity 75 and the other set of bearings 52 C and D is located in the exhaust turbine bearing cavity 76. For economy reasons each bearing of both sets can be identical. The set of bearings 52 A and B located inside compressor bearing cavity 75 are lubricated by hydraulic fluid via line 78 connected to hydraulic turbine discharge line 94. Separate bearing drain line 79 discharges lubricant fluid from compressor bearing cavity 75 into expansion tank 88 where any entrained air is separated from the hydraulic flow returning back through venturi 101 and via line 85 into pump 81.

Another set of bearings located in exhaust turbine bearring cavity 76 are lubricated through line 104 by standard engine oil provided by lubrication pump 106 located customarily in the engine oil sump of engine 68.

Bearing Cavity Seals

Compressor bearing cavity 75 and hydraulic turbine discharge cavity 57 are sealed at each end by carbon face seals 54. Exhaust turbine bearing cavity 76 is sealed at the exhaust turbine 51 side by a standard turbocharger limited leakage seal 59 allowing a small amount of exhaust gasses to enter from exhaust turbine 51 into exhaust turbine bearing cavity 76 and allowing a mixture of lubricant oil and exhaust gasses to return to engine 68 via line 107.

Elongated shaft 53 serves as a stacking shaft for face seals 54, spacer tube 55, hydraulic turbine wheel 61, hollow compressor shaft 108, spacer tube 51 and compressor wheel 62. Nut 91 is torqued in a conventional manner compressing all components on the shaft into one solid rotating assembly.

It should be understood that the specific form of the invention illustrated and described herein is intended to be representative only, as certain changes may be made therein without departing from the clear teachings of the disclosure. For example, the present hybrid supercharger as described herein could be used in series with a standard prior art turbocharger. The two bearings driven by engine oil could be replaced by a single bearing and the two bearings driven by hydraulic fluid could be replaced by a single bearing. Compressor units other than that of Turbonetics could be used for superchargers. Turbine wheels with diameters as low as 0.350 inch and as large as 2.0 inches could be utilized effectively under the teachings of this invention with the diameter of the nozzle exit surface slightly larger. The number of turbine blades could be increased or decreased within the range of about 18 to 40. With changes obvious to persons skilled in the art, the unit described above could be driven with other fluids such as water. Nozzle angles as small as 8 degrees and as large as 30 degrees could be used. The hydraulic system configurations shown in figures can be improved by employing a variable displacement piston pump, such as Vickers Model PVB15RSY-31-CM-11 in which case the bypass valve 83 could be eliminated.

Alternately, a second bypass valve could be added in parallel with valve 83 in order to provide a better stepwise control of the hydraulic systems. Accordingly, reference should be made to the following appended claims in determining the full scope of the invention.

I claim:

1. A single shaft hydraulic supercharger system for an internal combustion engine having an engine lubrication system lubricated by engine oil, said supercharger system comprising:
A) a supercharger shaft,
B) a compressor mounted on and driven by said shaft, said compressor defining a bearing cavity and configured to charge air into said engine,
C) an engine exhaust turbine, defining a turbine bearing cavity, mounted on and configured to drive said shaft when supplied with engine exhaust gases,
D) a hydraulic turbine mounted on and configured to drive said shaft when supplied with hydraulic fluid under pressure,
E) a first bearing shaft support comprising at least one hydraulic fluid lubricated bearing mounted in said compressor bearing cavity,
F) a hydraulic fluid lubrication line for providing hydraulic fluid lubrication to said at least one hydraulic fluid lubricated bearing,
G) a second bearing shaft support comprising at least one engine oil lubricated bearing mounted in said exhaust turbine bearing cavity, and
H) an engine oil lubrication line for providing engine oil lubrication to said at least one engine oil lubricated bearing.

2. A supercharger system as in claim 1 wherein said at least one hydraulic fluid lubricated bearing is two hydraulic fluid lubricated bearings and said at least one engine oil lubricated bearing is two engine oil lubricated bearings.

3. A supercharger system as in claim 1 wherein said hydraulic turbine is a high speed hydraulic radial inflow turbine drive comprising:
(1) a turbine nozzle body defining a turbine nozzle body outlet surface and comprising a hydraulic fluid cavity and a plurality of nozzles each of said nozzles providing a passageway for hydraulic fluid to pass inwardly from said hydraulic fluid cavity to said outlet surface and defining a nozzle centerline, where each of said nozzle centerlines:
(A) intersects said turbine body outlet surface at a point of intersection on a circle is concentric about said shaft axis and defines a nozzle exit circle and
(B) forms an angle of about 8 to 30 degrees with a tangent to said nozzle exit circle at said point of intersection,
(2) a radial in-flow hydraulic turbine wheel assemble comprising a plurality of radial flow turbine blades on a blade circle having a diameter of less than 2 inches; said turbine wheel assembly being arranged in relation to said shaft and said turbine body outlet surface such that hydraulic fluid discharged from said nozzles impinge on said blades to cause rotation of said turbine wheel and said shaft.

4. A supercharger system as in claim 1 wherein said system further comprises:
A) a hydraulic pump driven by said engine shaft supplying hydraulic fluid of a hydraulic fluid system to said hydraulic turbine and a hydraulic pump controlled bypass means to permit output flow or said first hydraulic pump to bypass said supercharger upon direction of said flow controller and a hydraulic venturi unit defining a main inlet, an outlet and a low pressure throat section,
B) an expansion tank,
C) a lubrication piping means providing a lubrication route for a portion of said hydraulic fluid flow from said turbine drive to said at least one hydraulic fluid lubricated bearing to said expansion tank and to said low pressure throat section of said venturi unit.

5. A hydraulic supercharger system for supercharging an internal combustion engine defining a shaft comprising:
(A) a supercharger comprising:
1) a shaft defining a shaft axis and supported by supercharger bearings,
2) a high speed hydraulic radial inflow turbine drive comprising:
(a) a turbine nozzle body defining a turbine nozzle body outlet surface and comprising a hydraulic fluid cavity and a plurality of nozzles each of said nozzles providing a passageway for hydraulic fluid to pass inwardly from said hydraulic fluid cavity to said outlet surface and defining a nozzle centerline, where each of said nozzle centerlines:
(i) intersects said turbine body outlet surface at a point of intersection on a circle is concentric about said shaft axis and defines a nozzle exit circle and
(ii) forms an angle of about 8 to 30 degrees with a tangent to said nozzle exit circle at said point of intersection,
(b) a radial in-flow hydraulic turbine wheel assemble comprising a plurality of radial flow turbine blades on a blade circle having a diameter of less than 2 inches; said turbine wheel assembly being arranged in relation to said shaft and said turbine body outlet surface such that hydraulic fluid discharged from said nozzles impinge on said blades to cause rotation of said turbine wheel and said shaft,
3) a compressor driven by said hydraulic turbine drive,
(B) a first hydraulic pump driven by said shaft supplying hydraulic fluid of a hydraulic fluid system to said supercharger,
(C) a hydraulic venturi unit defining a main inlet, an outlet and a low pressure throat section,
(D) an expansion tank,
(E) a main hydraulic piping means providing a hydraulic circulation loop for hydraulic fluid to flow from said pump, to drive said hydraulic turbine drive, to said main inlet of said venturi unit, through said venturi unit, to said venturi outlet and back to said pump,
(F) a supercharger bypass system comprising a controlled bypass valve and a piping means to permit a portion of said hydraulic fluid flow to bypass said supercharger turbine drive,
(G) a lubrication piping means providing
1) a lubrication route for a portion of said hydraulic fluid flow from said turbine drive to at least one bearing supporting said shaft to said expansion tank and to said low pressure throat section of said venturi unit,
2) a lubrication route from and engine oil sump of said engine to at least one bearing supporting said shaft and back to said engine, and
(H) an engine exhaust driven turbine mounted on said shaft and driven by exhaust gasses from said engine.

5. A system as in claim 5 and further comprising an oil cooler located within said hydraulic circulation loop.

6. A supercharger system as in claim 1 and further comprising a turbocharger system arranged in series with said supercharger system.
